(19) United States
(12) Patent Application Publication
(10) Pub. No.: US 2023/0137780 A1
(43) Pub. Date: May 4, 2023

(54) DRIVEN FAN FOR VEHICLE WHEEL BRAKE

(71) Applicant: HL MANDO CORPORATION, Pyeongtaek-si (KR)

(72) Inventor: Hatem SHAHIN, Pfaffenhofen (DE)

(73) Assignee: MANDO CORPORATION, Pyeongtaek-si (KR)

(21) Appl. No.: 17/970,828

(22) Filed: Oct. 21, 2022

(30) Foreign Application Priority Data
Oct. 29, 2021 (DE) 10 2021 212 228.0

(51) Int. Cl. F16D 65/847; F16D 65/00

(52) U.S. Cl. CPC F16D 65/847; F16D 65/0031

(57) ABSTRACT

The invention relates to a fan for a wheel brake of a vehicle, the fan comprising: a coupling portion for coupling the fan to the vehicle; a blade assembly that is rotatable relative to said coupling portion to generate an air flow; and a drive unit for rotating the blade assembly. Also, a method of operating such a fan is disclosed.

### TECHNICAL FIELD

The invention relates to a fan, to a vehicle wheel arrangement and to a method of operating a fan for a wheel brake of a vehicle.

### BACKGROUND

It is known to provide the wheels of a vehicle with wheel brakes that are each adapted to brake one of said wheels. Examples are disc brakes or drum brakes as commonly used e.g. in cars or trucks.

Especially in the case of disc brakes, substantial brake noise can be emitted into the surroundings when applying the brake. For example, high-pitched squeal noises can be emitted from time to time which impair driver comfort. Main sources of squeal noise are friction and relative motion between the brake pads and the brake disc which cause the brake disc as well as further brake and axle components to vibrate.

So far, it is often attempted to reduce the emission of brake noises by suitable material selections and adapting the designs of e.g. the brake pads or brake disc. An example can be found in DE 10 2018 216346 A. It is also known to modify other components of the wheel brake components or of the wheel axle to which the wheel is connected.

Yet, adapting the designs of existing components of a wheel brake, e.g. of its brake pads, may not be possible in each scenario because it may lead to disadvantages with respect to other component characteristics, such as volume, weight or costs. Further, while existing solutions achieve some improvement, there is still room for further reducing the emission of brake noise.

### SUMMARY

Therefore, it is an object of the invention to limit the emission of brake noise in wheel brakes of vehicles.

This object is solved by the subject matter according to the attached independent claims. Preferred embodiments are defined in the description and in the dependent claims.

Accordingly, a fan for a wheel brake of a vehicle is disclosed, the fan comprising: a coupling portion for coupling the fan to the vehicle; a blade assembly that is rotatable relative to said coupling portion to generate an air flow; and a drive unit for rotating the blade assembly.

With such a fan, it is possible to at least partially dampen, dissipate or cancel already generated brake noise that is emitted by the wheel brake into the surroundings of the vehicle. The fan may in particular help to reduce airborne noise. It may be provided in addition to or as an alternative to known component modifications which attempt to prevent the generation of brake noise in the first place.

The present disclosure thus concerns a new strategy for limiting the emission of brake noises which opens up new possibilities for improvement and may allow for less comprehensive modifications of existing brake components. For example, the presently disclosed solution can be retrofitted to existing wheel brakes.

The fan may be positioned adjacent to, opposite to and/or facing the wheel brake. It may rotate in a plane that extends in parallel to a brake disc of the wheel brake. It may rotate in a plane that extends at angle to a vertical (spatial) plane, the angle for example having a value ranging from 2° and 10°, in particular from 2° and 5°. Additionally or alternatively, at least some of the blades may extend at an angle to a vertical (spatial) plane, the angle for example having a value ranging from 3° to 8°. Generally, an axis of rotation of the fan may extend in parallel to or coincide with an axis of rotation the wheel and/or with a brake disc of the wheel brake. Preferably, a space between the fan and in particular its blade assembly and the wheel brake may be free of any further components or obstacles that could block the generated airflow. Providing a respective arrangement of the fan close of the wheel brake is efficient for dissipating brake noise.

Apart from reducing brake noise, the presently disclosed solution can also help to improve cooling of the wheel brake and may limit the emission of brake dust. This is because the generated airflow can cool e.g. a brake disc of the wheel brake and/or may prevent brake dust from being emitted into the surroundings. According to embodiments discussed below, the fan may instead collect at least some of the brake dust, e.g. by comprising adhesive surfaces to which the brake dust adheres. Additionally or alternatively, by way of the generated airflow the fan may blow at least part of the brake dust to a dust collecting depository or dust collecting surface close to or comprised by the wheel brake.

The fan may be rotated by the drive unit with at least one defined speed. The generated airflow may help to limit the emission of brake noises by dissipating and/or disturbing acoustic waves generated during braking. For example, it may dampen movements of pressed air layers causing squeal noises.

The at least one speed of rotation may be selected based on simulations and/or experiments in order to achieve a desired brake noise dissipation. Generally, it is preferred to drive the fan so that it emits harmonic noises that are not disturbing from a driver's perspective.

The drive unit may provide a driving force and/or a driving torque independently of other drive units and independently of movements of other components of the vehicle. Differently put, the fan may be independently rotatable (e.g. independently with respect to the remainder of the vehicle). It may thus form a stand-alone and/or autonomously driven unit that can be retrofitted to existing vehicles.

The drive unit may be or comprise at least one electric motor. A rotatable part of said motor may be connected to the blade assembly. A non-rotatable part of said motor may be connected to the coupling portion (which may generally be non-rotatable). The drive unit may comprise a controller that e.g. comprises at least one processor (e.g. a CPU or a microprocessor). The controller may control the rotation of the blade assembly and may in particular maintain a desired rotational speed thereof.

The drive unit and in particular optional controller thereof may be connected to a data bus and/or to at least one further vehicle controller. This way, the drive unit may determine or be signaled that a brake activation takes place. Likewise, this way the drive unit may determine or be signaled any of the vehicle parameters discussed herein.

The drive unit may include a stop or brake function to prevent undesired rotations of the fan, e.g. passive rotations caused by an airstream during driving. In case of an optional collapsible configuration of the blade assembly (see below), such a brake function may not be necessary.

The blade assembly may comprise at least one blade and preferably a plurality of blades. These may be arranged at equal distances to one another. Differently put, the blades can be regularly distributed around a rotational axis of the fan. The blades may be flat elongated members. They form a closed surface. Alternatively, they comprise slots, apertures or holes. The surface of the blades may be smooth. Alternatively, it may be structured (i.e., may be non-smooth), for example, by comprising a distributions of shape elements, such as local projections or local recesses, or by being waved. This may increase the desired noise cancellation effect.

The coupling portion may e.g. comprise or be a connecting sleeve or a connecting bushing. It may be mechanically fixed to the vehicle, e.g. by way of screws, by welding or by gluing. An inner side (in particular an inner circumferential surface) of the coupling portion may contact the vehicle component to which the fan is fixed. An outer side (in particular an outer circumferential surface) may connect to the drive unit, in particular to a non-rotatable part thereof.

Overall, the fan disclosed herein is marked by a compact and lightweight design that is accompanied by low costs.

According to a further embodiment, the drive unit may be adapted to drive (i.e. rotate) the blade assembly at a rotational speed that is different from a rotational speed of at least one of: a wheel or a wheel hub of the vehicle; a rotatable component of the wheel brake, in particular a brake disc.

This embodiment thus underlines that a rotation of the blade assembly may be generated independently of e.g. the driving state of the vehicle. This is different from (theoretically) fixing a fan to any of the above components so that the fan jointly rotates therewith. Rather, due to the presently enabled independent rotation, an optimal rotational speed can be set to achieve the desired noise cancellation independently of e.g. the wheel's speed of rotation.

Generally, the wheel arrangement comprising the wheel brake may be configured according to existing solutions. That is, the wheel hub may be connected to a rim which carries a tire. The brake disc may be mounted on the wheel hub and/or on an axle component that is likewise connected to the wheel hub. Preferably, the wheel hub, rim and brake disc are at least indirectly coupled to one another for a joint rotation around a common rotational axis. Even though the fan may be connected and in particular fixed to any of these components by way of its coupling portion, the blade assembly may rotate relative thereto e.g. by being driven at an individual rotational speed.

According to a further embodiment, the drive unit is configured to drive the blade assembly for generating an air flow by means of which brake noises of the wheel brake can be dampened. Differently put, a rotational speed of the blade assembly may be set to provide a noise cancelling effect in particular with respect to squeal noises.

It is generally preferred that the direction of the generated airflow is directed inwardly, i.e. into the vehicle and not into the surroundings. For example, the generated airflow may be directed away from a rim of the wheel that is braked by the wheel brake and is preferably directed towards the wheel brake instead. It may generally flow along and/or in parallel to an axis of rotation of the fan or the wheel.

According to one example, the drive means is selectively and/or temporarily activatable for generating the rotation. The selective activation may depend on at least one operating parameter of the vehicle. It may e.g. selectively take place depending on said operating parameter fulfilling an activation condition. If not activated, the blade assembly may not be driven and may not rotate.

By only selectively activating the drive unit and thus the fan, the fan can be rotated only as needed for noise cancellation. This is beneficial with respect to energy consumption and e.g. avoids generating unnecessary drag.

The operating parameter may be an activation state of the wheel brake. The activation condition of the drive unit may be fulfilled if the activation state is present. Put differently, the fan may selectively be rotated when the wheel brake is activated.

Additionally or alternatively, the operating parameter may be a movement parameter of the vehicle, in particular a vehicle speed or a vehicle acceleration. The vehicle acceleration may include negative accelerations, thus indicating and extent of the applied brake forces. The activation condition of the drive unit may be fulfilled when the vehicle speed of the vehicle acceleration (in particular an absolute value thereof) exceeds a defined threshold. Said threshold may indicate an overall extent of the brake forces at which a risk of inacceptable brake noise emission increases.

Generally, a speed of rotation of the fan may at least amount to the speed of rotation of that a vehicle wheel assumes at a vehicle travelling velocity of in between 20 km/h to 80 km/h. It has been found that this advantageous for cancelling squeal noises which are perceived to be particularly disturbing at these travelling velocities (e.g. due to said travelling velocities being typical for inner city traffic). Nonetheless, the fan can at least in principal be configured to rotate independently of the wheel's speed of rotation, as generally disclosed herein.

According to a further embodiment, the wheel brake comprises a brake disc and a vehicle wheel coupled to the wheel brake comprises a rim, wherein the blade assembly is arrangeable between the brake disc and the rim (e.g. when viewed along a rotational of the any of the fan, wheel and brake disc). This provides a compact design by making use of an otherwise typically unoccupied space between the rim and brake disc.

In one example, the coupling portion is couplable (or coupled) to an inner side of the rim or to the wheel brake, in particular to a brake disc thereof. This coupling may include forming a mechanical connection between said members and in particular fixing the coupling portion to the rim or to the brake disc.

The coupling to the brake disc may take place at a center portion of the brake disc which is connectable or connected to a wheel hub. According to known configurations, this center portion may axially protrude relative to the remainder of the brake disc. An outer circumferential surface of said axially protruding center portion may serve as a seat to which the coupling portion of the fan can be coupled. The axially protruding center portion may also be referred to as a brake disc hat (German: Bremsscheiben-Topf)

The blade assembly may be configured to change between a first configuration, in which the blade arrangement has a first (preferably larger) radial extension, and a second configuration in which the blade arrangement has a second (preferably smaller) radial extension, the first and second radial extensions being different. Differently put, the blade assembly may be collapsible, in particular radially collapsible. The collapsed state may be equivalent to the second configuration above. The non-collapsed (i.e. extended) state may be equivalent to the first configuration above.

The collapsed state (i.e. the second configuration) may be provided when not driving the fan. The non-collapsed state and first configuration may be provided when driving the fan. Thus, similar to the optional selective activation of the drive unit, the blade assembly may be selectively and/or temporarily (radially) extended. The extension may be activated when the drive unit is activated and/or in similar cases of selectively activating the drive unit as discussed above. Accordingly, the extension may equally take place depending on any of the above discussed operating parameters and/or activation conditions.

For changing between the first and second configuration, the blades of the blade assembly may be folded and unfolded. Additionally or alternatively, they may be rotated (e.g. in a first direction) to assume an erected (first) configuration and rotated (e.g. in an opposite direction) to assume a lying (second) configuration. In the latter case, the blades may extend at an angle to the radial direction of e.g. more than 20° and up to 90°. Additionally or alternatively, the blades may be radially extended and retracted by means of a linear movement and/or by comprising a telescope mechanism.

The blade assembly may include at least one actuator (preferably one actuator per blade) to change between the first and second configuration.

By only selectively extending or erecting the blades, drag of the fan is reduced. Also, its size and visibility can be reduced when not being activated. This may be preferably in terms of appearance.

According to a further aspect, the fan is adapted to collect brake dust emitted by the wheel brake. For doing so, at least part of the surface of e.g. the blade assembly may comprise a coating to which the brake dust may adhere (e.g. a glue coating). This way, environmental pollution is reduced. The fan (in particular its blade assembly) can be replaced when having collected a significant amount of brake dust to restore its dust-collecting capabilities.

The invention also relates to a vehicle wheel arrangement, comprising: a vehicle wheel (e.g. comprising a rim and a tire); a wheel brake; a fan according to any of the aspects disclosed herein.

For example, when viewed along a rotational axis of the wheel, the fan and in particular at least a blade assembly thereof may be positioned between the vehicle wheel and the wheel brake (in particular a brake disc thereof).

The vehicle wheel and at least part of the wheel brake (e.g. a brake disc) may be mounted to a common wheel hub or to a common axle component. The wheel hub or axle component may be part of the vehicle wheel arrangement. Further disclosed is a method of operating a fan for a wheel brake of a vehicle, wherein the fan comprises a blade assembly for generating an air flow, the method comprising: generating a rotation of the blade assembly relative to (and thus at least partially independently of) at least one of: a wheel or wheel hub of the vehicle coupled to the wheel brake; a rotatable component of the wheel brake, in particular a brake disc.

The method may include any of the further steps and measures disclosed herein, e.g. in connection with a selective activation of the drive unit and/or a selective extension of the blade assembly. Generating the relative rotation is equivalent to setting a rotational speed of the fan (at least partially) independently of the wheel, wheel hub or rotatable component of the wheel brake, as discussed above, and is accompanied by the same advantages.

The features of the present invention may be combined in an advantageous fashion with further known features for reducing brake noise.

### BRIEF DESCRIPTION OF THE DRAWINGS

The invention will be explained further with reference to the figures in which same features are marked with same reference signs.

FIG. 1 is a cross-sectional view of a vehicle wheel arrangement comprising a fan according to a first embodiment.

FIG. 2 is a cross-sectional view of a vehicle wheel arrangement comprising a fan according to a second embodiment.

FIG. 3 is a view of a fan according to a third embodiment when assuming a radially collapsed configuration.

FIG. 4 is a view of the fan according to the third embodiment when assuming a radially extended configuration.

### DETAILED DESCRIPTION

Hereinafter, the present disclosure will be described with reference to the accompanying drawings presented as described above.

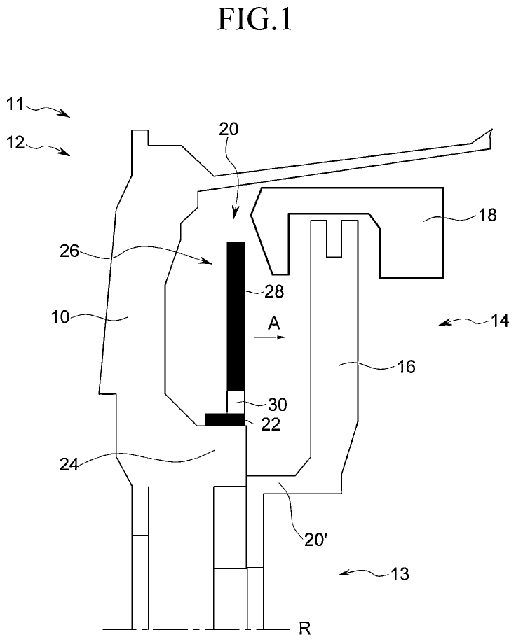

In the cross-sectional view of FIG. 1, a rim 10 of a vehicle wheel arrangement 12 and a wheel brake 14 of said vehicle wheel arrangement 12 are depicted. The wheel brake 14 is a disc brake. It comprises a brake disc 16 and a floating caliper 18 as well as further components, such as brake pads, which are not illustrated.

The rim 10 and the wheel brake 14 can have generally known configurations. Accordingly, they contact each other by way of an axially extending center portion 20′ of the wheel brake 14 contacting an inner side of the rim 10. In a generally known manner, bolts (not illustrated) may be inserted through through-holes (not illustrated) extending through the rim 10 and center portion 20′ to connect these components to a wheel hub. A position of the not illustrated wheel hub is indicated with reference sign 13 (reference sign 11 indicates a wheel of the vehicle).

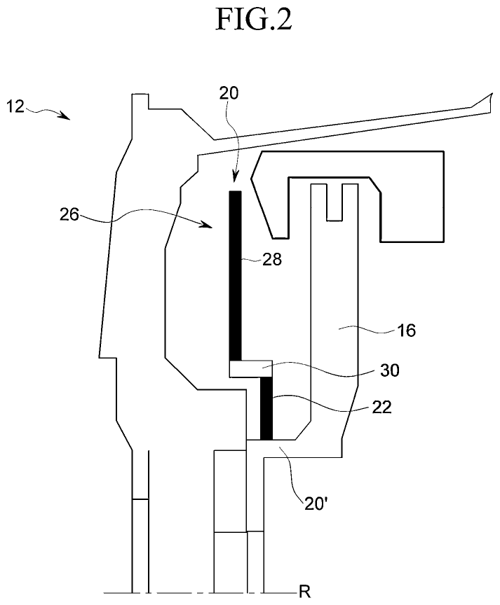

In FIGS. 1 and 2, the wheel arrangements 12 are only partially depicted. Specifically, only an upper part with respect to a rotational axis R of the rim 10 and brake disc 16 are depicted. Said components 10, 16 are preferably rotationally symmetric with respect to the rotational axis R. Any references to axial and radial directions refer to said rotational axis R with radial directions extending orthogonally thereto.

Referring to FIG. 1, a fan 20 is shown which is positioned in a space between an inner side of the rim 10 and an outer side of the brake disc 16. The terms “inner” and “outer” refer to an orientation of the wheel arrangement 12 at and with respect to a vehicle. In FIG. 1, a left side of the rim 10 faces outward and a left end of the rotational axis R points outward, whereas a right side of the brake disc 16 (as well as a right end of the rotational axis R) faces inward.

The fan 20 comprises a coupling portion 22. By way of example, this coupling portion 22 is configured as a sleeve-like member that is pushed onto an axially and inwardly protruding portion 24 of the rim 10. Accordingly, an inner circumferential face of the coupling portion 22 contacts an outer circumferential face of the rim 10, and in the example shown of the respective portion 24 of the rim 10.

The connection between the coupling portion 22 and the rim 10 preferably includes an additional mechanical fixation between these components, e.g. by means of screws. Generally, the coupling portion 22 is non-rotatable relative to the rim 10 but rotates jointly therewith.

It is to be noted that in FIG. 1 (but also in FIG. 2) the fan 20 is configured rotationally symmetric with respect to the rotational axis R.

The fan 20 of FIG. 1 further comprises a blade assembly 26, one blade 28 of which is visible in FIG. 1. Preferably, at least three or four blades 28 are provided and are positioned at equal angular or circumferential distances to each other.

The blade assembly 26 is connected to the coupling portion 22 by a drive unit 30 of the fan 20. Merely as an example, the drive unit 30 is configured as a ring-shaped member that connects an outer circumferential face of the coupling portion 22 to the blades 28 of the blade assembly 26.

In the example shown, the drive unit 30 comprises an electric motor. The electric motor preferably has an inner stator-outer rotor configuration, with the stator preferably being fixed to the coupling portion 22 and the rotor preferably being fixed to the blades 28.

The drive unit 30 is configured to rotate the blades 28 about the rotational axis R. A rotational speed of the blades 28 can be set to be different from a rotational speed of the rim 10 and brake disc 16. That is, the blades 28 can rotate relative to the rim 10 and wheel brake 14. This may be referred to as rotating the fan 20 independently of a rotation of the wheel brake arrangement 12. Put another way, at least a part of the rotational speed of the fan 20 is generated independently of a rotational speed of the rim 10 and wheel brake 14 by means of the drive unit 30.

In the example shown, the blades 28 are rotated to generate an air flow A that is directed inwardly, and thus towards the brake disc 16 and away from the rim 10. Further, the rotational speed of the blades 28 is set to generate an air flow A of sufficient strength to achieve a desired noise cancellation effect of brake squeal, and in particular of dominant acoustic frequencies associated with an expected brake squeal. The relation between the needed strength of the air flow A (and thus the rotational speed of the blades 28) for achieving a desired noise cancellation effect can be determined by way of experiment or simulation.

The drive unit 30 comprises a controller (not illustrated). By way of slip rings (not illustrated), data signals can be transferred from a data bus of the vehicle to data lines attached to the rim 10 (not illustrated) and connected to the controller of the drive unit 30. Similarly, electric energy can be transferred to the drive unit 30 by way of such a slip ring and such electric lines (not illustrated).

The controller of the drive unit 30 selectively activates the drive unit to rotate the blades 28 when receiving a respective activation signal through the above-discussed data connection. Alternatively, the controller may determine that an activation condition is fulfilled based on other data received by said data connection, e.g. data on operating parameters of the vehicle. These may indicate, for example, an activation of the wheel brake 14 and/or that a negative vehicle acceleration exceeds a defined threshold.

As additional advantageous effects, the—preferably only selectively generated—air flow A (that is, selectively generated when the wheel brake 14 is activated) also provides a cooling effect for the brake disc 16. Further, brake dust can be prevented from being expelled outwardly into the surroundings. For example, the blades 28 or an outer surface of the brake disc 16 may at least partially be coated with an adhesive to which the brake dust adheres.

FIG. 2 shows an alternative configuration of the fan 20, the remaining components of the wheel arrangement 12 being unchanged from FIG. 1. Again, the fan 20 comprises a radially extending blade assembly 26, one blade 28 of which is visible in FIG. 2. Further, a drive unit 30 that is similarly operable to the drive unit 30 of FIG. 1 connects the blades 28 to a coupling portion 22.

In contrast to the embodiment of FIG. 1, the coupling portion 22 is coupled and preferably mechanically fixed to the disc brake 16. Specifically, an inner circumferential face of the again ring- or sleeve-like coupling portion 22 is connected to an outer circumferential face of the axially protruding center portion 20′ of the brake disc 16 (also referred to as a brake hat in the technical field). Again, providing data signals and electric power to the drive unit 30 can be accomplished by way of slip rings (not illustrated).

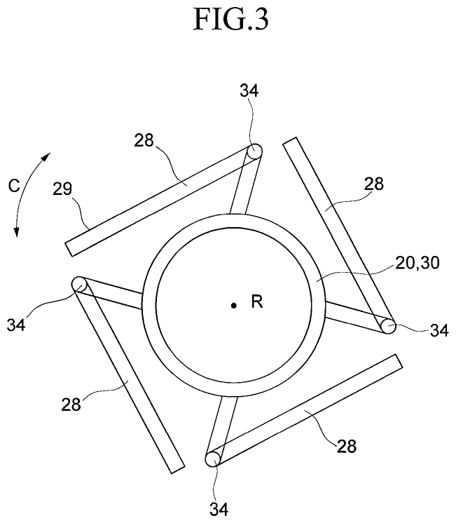

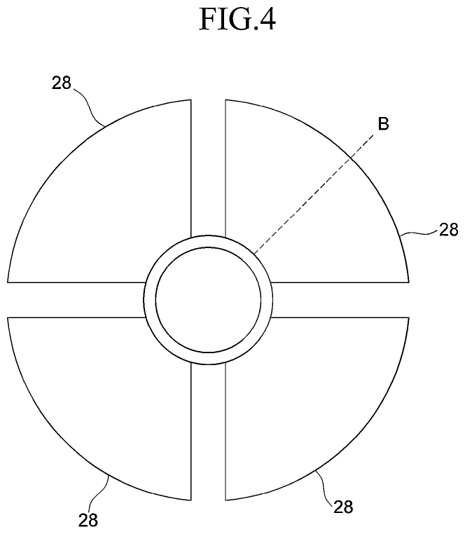

In FIGS. 3 and 4, different configurations of a fan 20 are shown. The fan 20 can be used in any of the embodiments of FIGS. 1 and 2, but also independently thereof.

The fan 20 is depicted with the rotational axis R extending towards the viewer (i.e., orthogonally to the image plane). Merely as a simplification, the drive unit 30 and the connecting portion 22 are illustrated as a joint ring-shaped member. Four blades 28 are distributed along an outer circumferential surface of the drive unit 30. The blades 28 assume a collapsed or radially retracted configuration in FIG. 3. In order to be able to do so they each comprise a rotatable joint 34. The rotatable joints 34 each comprise an electric motor, thus forming actuators for folding and unfolding the blades 28.

Specifically, in order to change between the depicted collapsed configuration and a non-collapsed configuration, the joints 34 can rotate a radially outer portion of the blades 28 in a circumferential direction. This is exemplified for one radially outer portion 29 in FIG. 3 by a respective arrow C. When rotated so as to assume the non-collapsed state, the blades 28 may have a substantially linear unfolded shape.

In FIG. 4, the respective blades 28 are depicted in their non-collapsed configuration. It is evident that their radial extension is increased with respect to the folded configuration of FIG. 3. Merely as a simplification, the rotational joints 34 are not depicted in FIG. 4. Further, compared to FIG. 3 an area of the blades 28 that faces the viewer is enlarged. This can be achieved when additionally rotating the blades 28 about an axis B indicated for one of the blades 28 in FIG. 4. However, this is a merely optional feature. The invention may be configured in such a way that the folding and unfolding by means of the rotational joints 34 of FIG. 3 represents the only possibility to change a configuration of the blades 28 with respect to their extent and/or orientation.

Extending the blades 28 from their radially collapsed configuration takes place when activating the wheel brake 14 and in preparation of activating the drive unit 30. Thus, when the fan 20 is not driven to be rotated, it assumes the collapsed configuration. This helps to reduce drag and provides a compact—and thus preferred—appearance of the fan 20.

What is claimed is:

1. A fan for a wheel brake of a vehicle, the fan comprising:
a coupling portion for coupling the fan to the vehicle;
a blade assembly that is rotatable relative to said coupling portion to generate an air flow; and
a drive unit for rotating the blade assembly.

2. The fan according to claim 1, characterized in that said drive unit is adapted to drive said blade assembly at a rotational speed that is different from a rotational speed of at least one of:
wheel or a wheel hub of the vehicle, which are coupled to the wheel brake; and
a rotatable component of the wheel brake, in particular a brake disc.

3. The fan according to claim 1, characterized in that the drive unit is configured to drive the blade assembly for generating an air flow by means of which brake noises of the wheel brake can at least partially be dampened.

4. The fan according to claim 1, characterized in that the drive unit is selectively activatable for generating the rotation, the selective activation depending on at least one operating parameter of the vehicle.

5. The fan according to claim 4, characterized in that the operating parameter is one of the following:
an activation state of the wheel brake;
a movement parameter of the vehicle, in particular a vehicle speed or a vehicle acceleration.

6. The fan according to claim 1, characterized in that the wheel brake comprises a brake disc and a vehicle wheel coupled to the wheel brake comprises a rim, wherein the blade assembly is arrangeable between the brake disc and the rim.

7. The fan according to claim 6, characterized in that the coupling portion is couplable to an inner side of the rim or to the brake disc.

8. The fan according to claim 1, characterized in that the blade assembly is configured to change between a first configuration, in which the blade arrangement has a first radial extension, and a second configuration in which the blade assembly has a second radial extension, the first and second radial extensions being different.

9. The fan according to claim 1 characterized in that the fan is adapted to collect brake dust emitted by the wheel brake.

10. A vehicle wheel arrangement, comprising:
a vehicle wheel;
a wheel brake; and
a fan according to claim 1

11. A method of operating a fan for a wheel brake of a vehicle, wherein the fan comprises a blade assembly for generating an air flow, the method comprising: generating a rotation of the blade assembly relative to at least one of:
a wheel or wheel hub of the vehicle coupled to the wheel brake; and
a rotatable component of the wheel brake, in particular a brake disc.
